(19) United States
(12) Patent Application Publication
(10) Pub. No.: US 2012/0170849 A1
(43) Pub. Date: Jul. 5, 2012

(54) IMAGE PROCESSING APPARATUS AND COMPUTER-READABLE RECORDING MEDIUM

(75) Inventor: Masaaki SAKA, Toyohashi-shi (JP)

(73) Assignee: Konica Minolta Business Technologies, Inc., Tokyo (JP)

(21) Appl. No.: 13/341,566

(22) Filed: Dec. 30, 2011

(30) Foreign Application Priority Data
Jan. 4, 2011 (JP) 2011-000057

(51) Int. Cl. G06K 9/46

(52) U.S. Cl. 382/195

(57) ABSTRACT

An image processing apparatus includes: an isolated point detecting unit that detects isolated points in image data; a line-shaped region extracting unit that extracts line-shaped regions in the image data, as character line candidate regions; an isolated point type determining unit that determines a representative pixel of each isolated point in each line-shaped region to be a pixel of interest, determines discontinuity of each line-shaped region around the pixel of interest for each isolated point, determines an isolated point determined to have discontinuity to be a true isolated point, and determines an isolated point determined to have no discontinuity to be a pseudo isolated point; and a halftone-dot region determining unit that determines a halftone-dot region, based on isolated point type determination results for the respective isolated points detected by the isolated point detecting unit.

This application is based on Japanese Patent Application No. 2011-000057 filed on Jan. 4, 2011, the contents of which are hereby incorporated by reference.

### BACKGROUND OF THE INVENTION

1. Field of the Invention

The present invention relates to an image processing apparatus and a technique related thereto.

2. Description of the Background Art

In an image forming apparatus that forms an image based on a scanned image, etc., a plurality of types of regions such as character regions and halftone-dot regions are distinguished from each other and each region is subjected to image processing, according to the type thereof (see Japanese Patent Application Laid-Open No. 2002-218235). For example, a smoothing process is performed on halftone-dot regions, thereby suppressing the occurrence of moiré, etc.

Note that Japanese Patent Application Laid-Open No. 2002-218235 describes detection of halftone-dot regions by an isolated point detection process.

However, as will be described later, when halftone-dot regions are determined only by an isolated point detection process, dots inside a character (pixels representing the lines of the character) are also extracted as pixels in a halftone-dot region. Then, if a smoothing process is performed on the halftone-dot region in terms of the prevention of moiré, etc., then a problem of a blurred character edge occurs.

### SUMMARY OF THE INVENTION

An object of the present invention is to provide an image processing technique capable of more appropriately extracting halftone-dot regions from an image containing both characters and halftone dots.

A first aspect of the present invention is directed to an image processing apparatus including: an isolated point detecting unit that detects isolated points in image data; a line-shaped region extracting unit that extracts line-shaped regions in the image data, as character line candidate regions; an isolated point type determining unit that determines a representative pixel of each isolated point in each line-shaped region to be a pixel of interest, determines discontinuity of each line-shaped region around the pixel of interest for each isolated point, determines an isolated point determined to have discontinuity to be a true isolated point, and determines an isolated point determined to have no discontinuity to be a pseudo isolated point; and a halftone-dot region determining unit that determines a halftone-dot region, based on isolated point type determination results for the respective isolated points detected by the isolated point detecting unit.

A second aspect of the present invention is directed to a non-transitory computer-readable recording medium having recorded therein a program for causing a computer to perform the steps of (a) detecting isolated points in image data; (b) extracting line-shaped regions in the image data, as character line candidate regions; (c) determining a representative pixel of each isolated point in each line-shaped region to be a pixel of interest, determining discontinuity of each line-shaped region around the pixel of interest for each isolated point, determining an isolated point determined to have discontinuity to be a true isolated point, and determining an isolated point determined to have no discontinuity to be a pseudo isolated point; and (d) determining a halftone-dot region, based on isolated point type determination results obtained in the step (c) for the respective isolated points detected in the step (a).

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing an MFP (image processing apparatus);

FIG. 2 is a diagram showing a functional block of a controller;

FIG. 3 is a flowchart showing operations related to image processing;

FIG. 4 is a flowchart showing a region determination process;

FIG. 5 is a flowchart showing an isolated point determination operation;

FIG. 6 is a diagram showing an example of a scanned image (a part);

FIG. 7 is a diagram showing an R-plane;

FIG. 8 is a diagram showing a G-plane;

FIG. 9 is a diagram showing a B-plane;

FIG. 10 is a diagram showing the processing results of an isolated point detection process;

FIG. 11 is a diagram showing the processing results of a line-shaped region extraction process;

FIG. 12 is an enlarged view showing a halftone-dot region in the scanned image;

FIG. 13 is an enlarged view showing portions in the vicinity of a character line region in the scanned image;

FIG. 14 is a diagram showing isolated points extracted from the halftone-dot region in FIG. 12;

FIG. 15 is a diagram showing isolated points extracted from the halftone-dot region and the character line region in FIG. 13;

FIG. 16 is a diagram showing line-shaped regions extracted from the halftone-dot region in FIG. 12;

FIG. 17 is a diagram showing line-shaped regions extracted from the halftone-dot region and the character line region in FIG. 13;

FIG. 18 is a diagram showing isolated point detection results and line-shaped region extraction results in connection with FIG. 12 in a superimposed manner;

FIG. 19 is a diagram showing isolated point detection results and line-shaped region extraction results in connection with FIG. 13 in a superimposed manner;

FIG. 20 is a diagram showing the scanned image in more detail;

FIG. 21 is a diagram showing the results of detection of black isolated points and the results of extraction of positive type line-shaped regions;

FIG. 22 is a diagram showing the results of detection of white isolated points and the results of extraction of negative type line-shaped regions;

FIG. 23 is a diagram showing pixels in the vicinity of a pixel of interest;

FIG. 24 is a diagram showing pixels in the vicinity of a pixel of interest;

FIG. 25 is a diagram describing an isolated point determination operation;

FIG. 26 is a diagram describing an isolated point determination operation;

FIG. 27 is a diagram describing an isolated point determination operation;

FIG. 28 is a diagram showing isolated points (true isolated points), etc., after the removal of pseudo isolated points;

FIG. 29 is a diagram showing true isolated points, etc., obtained by another isolated point determination operation; and

FIG. 30 is a diagram showing an image processing apparatus according to a variant, etc.

### DESCRIPTION OF THE PREFERRED EMBODIMENTS

An embodiment of the present invention will be described below with reference to the drawings.

<1. Configuration>

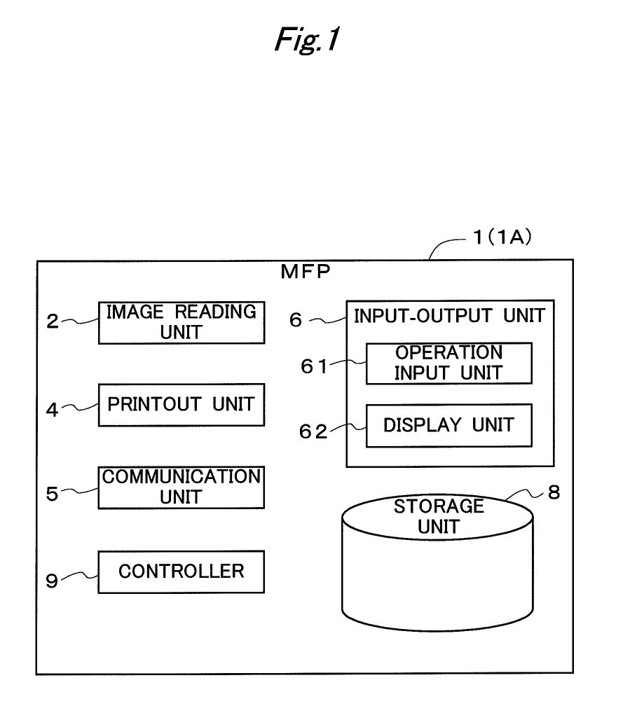

FIG. 1 is a schematic diagram showing an image processing apparatus 1 (1A). Here, the case in which the image processing apparatus 1 (1A) is configured as a multifunction peripheral (also abbreviated as MFP) is exemplified.

The MFP 1 is an apparatus having a scanner function, a printer function, a copy function, a facsimile function, etc. (also referred to as a multifunction product). Specifically, the MFP 1 includes an image reading unit 2, a printout unit 4, a communication unit 5, an input-output unit 6, a storage unit 8, and a controller 9. By allowing these units to operate in an integrated manner, the above-described functions are implemented.

The image reading unit 2 is a processing unit that optically reads a document placed in a predetermined position of the MFP 1 and thereby creates an image of the document (also referred to as a document image or a scanned image). The image reading unit 2 is also referred to as a scanner unit.

The printout unit 4 is an output unit that prints out an image on various types of media such as paper, based on image data on a target image.

The communication unit 5 is a processing unit capable of performing facsimile communication via a public telephone line, etc. Also, the communication unit 5 can perform network communication over a communication network. By using the network communication, the MFP 1 can give and receive various data to/from a desired target. In addition, by using the network communication, the MFP 1 can send and receive emails.

The input-output unit 6 includes an operation input unit 61 that accepts input to the MFP 1; and a display unit 62 that performs display output of various types of information.

The storage unit 8 is composed of a storage apparatus such as a hard disk drive (HDD). The storage unit 8 stores a document image, etc., created by the image reading unit 2, etc.

The controller 9 is a control apparatus that performs overall control of the MFP 1, and is configured to include a CPU and various semiconductor memories (a RAM, a ROM, and the like). Various functions of the MFP 1 are implemented by various processing units operating under control of the controller 9.

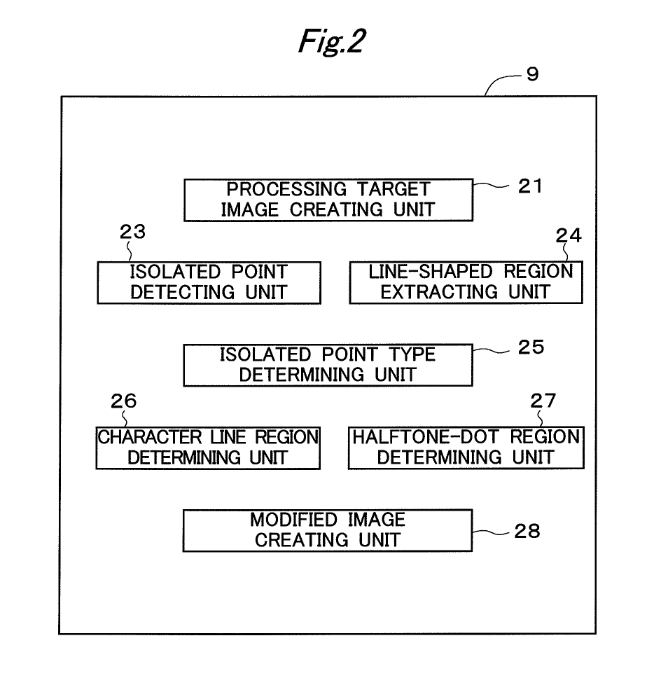

FIG. 2 is a diagram showing a functional block of the controller 9. As shown in FIG. 2, the controller 9 includes a processing target image creating unit 21, an isolated point detecting unit 23, a line-shaped region extracting unit 24, an isolated point type determining unit 25, a character line region determining unit 26, a halftone-dot region determining unit 27, and a modified image creating unit 28.

The processing target image creating unit 21 is a processing unit that creates, based on a scanned image, images for a region type determination process (also referred to as images for region type determination) for various regions (including halftone-dot regions, character line regions, and the like).

The isolated point detecting unit 23 is a processing unit that detects “isolated points” (described later) by performing an isolated point detection process on the scanned image (specifically, the above-described images for region type determination).

The line-shaped region extracting unit 24 is a processing unit that extracts pixels in a “line-shaped region” (described later) by performing an edge extraction process, etc., on the scanned image (specifically, the above-described images for region type determination).

The isolated point type determining unit 25 is a processing unit that determines the type of each isolated point detected by the isolated point detecting unit 23. The isolated point type determining unit 25 determines, as will be described later, whether each isolated point is a “true isolated point” or a “pseudo isolated point”.

The character line region determining unit 26 is a processing unit that determines character line regions in the scanned image, based on the extraction results (line-shaped region extraction results) obtained by the line-shaped region extracting unit 24 and the determination results (isolated point type determination results) obtained by the isolated point type determining unit 25.

The halftone-dot region determining unit 27 is a processing unit that determines halftone-dot regions in the scanned image, based on the detection results (isolated point detection results) obtained by the isolated point detecting unit 23 and the determination results (isolated point type determination results) obtained by the isolated point type determining unit 25.

The modified image creating unit 28 is a processing unit that creates a modified image in which appropriate image processing is performed on the character line regions and the halftone-dot regions which are determined by the character line region determining unit 26 and the halftone-dot region determining unit 27.

Various types of image processing are performed on the scanned image by the processing units 21 and 23 to 28, whereby a modified image is created. Then, the modified image is printed out by the printout unit 4, whereby a so-called copy function, etc., are implemented.

<2. Image Processing>

Next, image processing, etc., performed by the processing units 21 and 23 to 28 will be described.

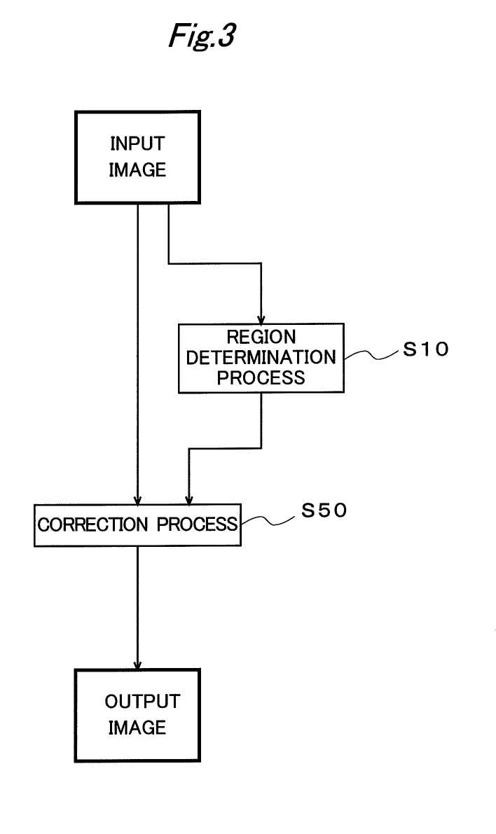

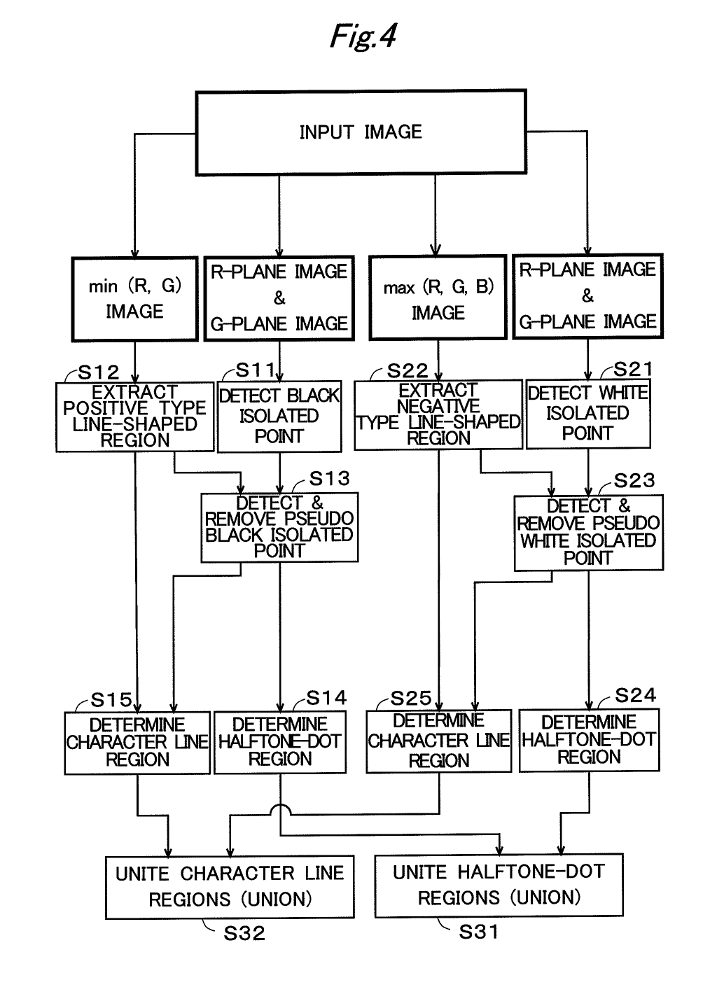

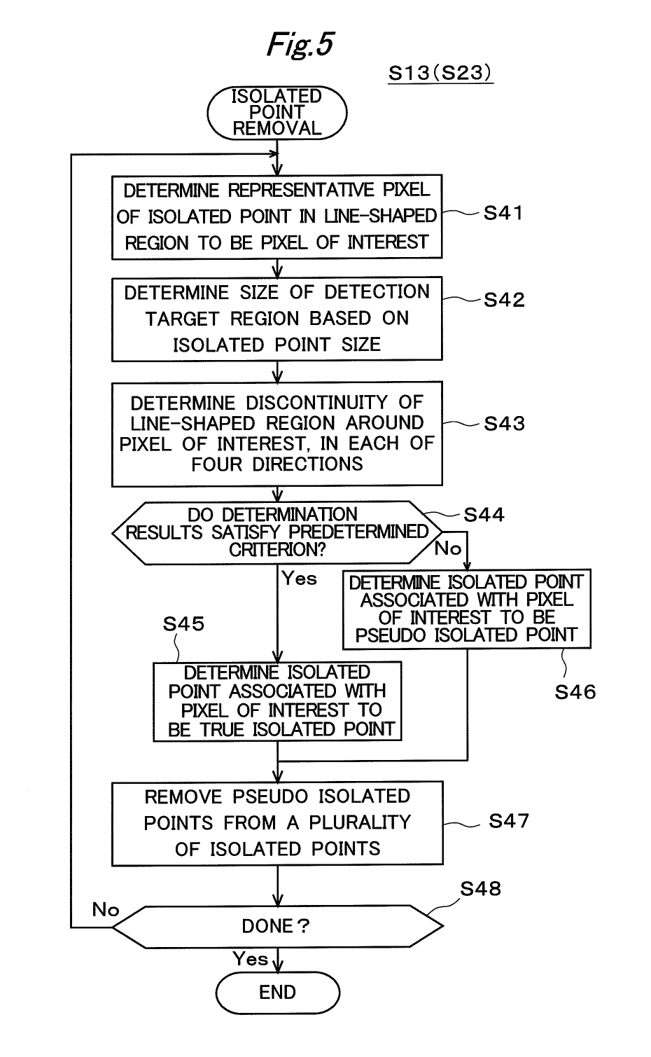

FIGS. 3 to 5 are flowcharts showing operations related to the image processing, etc. FIG. 3 is a diagram showing main operations and FIG. 4 is a diagram showing a part of FIG. 3 (region determination process) in detail. FIG. 5 is a diagram showing a part of FIG. 4 in more detail.

As shown in FIG. 3, in step S10, a region determination process is performed. By the region determination process, a region in a scanned image is divided into a plurality of types of regions (character line regions, halftone-dot regions, and the like). Specifically, as will be described later, the operation of determining the types of regions is performed using detection results concerning “line-shaped regions” and “isolated points” for the scanned image.

In step S50, the modified image creating unit 28 creates a modified image in which appropriate image correction processes according to the types of the respective regions are performed on the character line regions and the halftone-dot regions which are determined by the character line region determining unit 26 and the halftone-dot region determining unit 27, respectively. For example, a smoothing process is performed on the halftone-dot regions and an edge enhancement process is performed on the character line regions, whereby the modified image is created.

Thereafter, the modified image is printed out by the printout unit 4. Accordingly, a document image printout operation (a so-called copy function) is implemented.

FIG. 4 is a diagram showing detailed operations of the region determination process (step S10). With reference to FIG. 4, the region determination process will be described in detail.

In steps S11 to S15, the operation of determining the type of a region is performed using detection results concerning “positive type line-shaped regions” (described later) and “black isolated points” (isolated points each having a smaller grayscale value than its surrounding pixels (surrounding region)) in a scanned image. In addition, in parallel with the processes in steps S11 to S15, the processes in steps S21 to S25 are performed. In steps S21 to S25, the operation of determining the type of a region is performed using detection results concerning “negative type line-shaped regions” (described later) and “white isolated points” (isolated points each having a larger grayscale value than its surrounding pixels (surrounding region)) in the scanned image. In steps S31 and S32, the operations of finally determining the types of regions are performed using the determination results obtained in steps S11 to S15 and the determination results obtained in steps S21 to S25.

Note that prior to these processes, a min (R, G) image, a max (R, G, B) image, an R-plane image, a G-plane image, etc., are created as images for region type determination, based on the scanned image. Here, the min (R, G) image is an image obtained after conversion of the original full color image (scanned image) and is a grayscale image obtained by converting a minimum value between the R component value and G component value of each of the pixels forming the original full color image, into a new pixel value (grayscale value) of the pixel. Likewise, the max (R, G, B) image is an image obtained after conversion of the original full color image and is a grayscale image obtained by converting a maximum value among the R component value, G component value, and B component value of each of the pixels forming the original full color image, into a new pixel value of the pixel.

In this embodiment, as line-shaped regions (line-shaped regions forming the lines of a character, etc.), two types of regions, a positive type line-shaped region and a negative type line-shaped region, are detected. Specifically, a positive type line-shaped region is detected based on the min (R, G) image, and a negative type line-shaped region is detected based on the max (R, G, B) image. The positive type line-shaped region is a line-shaped region with a relatively dark color relative to a background color, and the negative type line-shaped region is a line-shaped region with a relatively light color relative to a background color. The positive type line-shaped region is also represented as a line-shaped region with a relatively low luminance relative to the background, and the negative type line-shaped region as a line-shaped region with a relatively high luminance relative to the background.

In addition, in this embodiment, based on the R-plane image, “black isolated points” are detected and “white isolated points” are also detected. Likewise, based on the G-plane image, “black isolated points” are detected and “white isolated points” are also detected. Note that here the B-plane image is not used for the process of detecting “black isolated points” and “white isolated points”. Note, however, that the configuration is not limited thereto and the B-plane image may also be used for the process of detecting “black isolated points” and/or “white isolated points”.

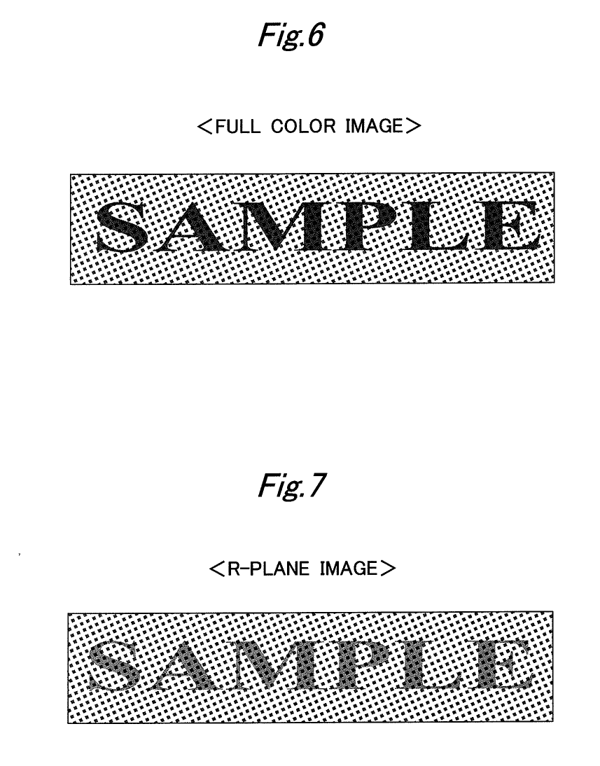

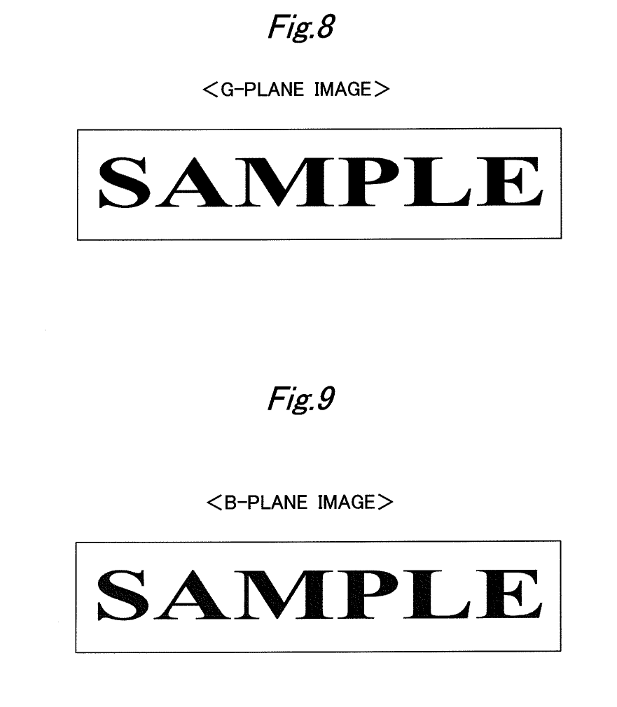

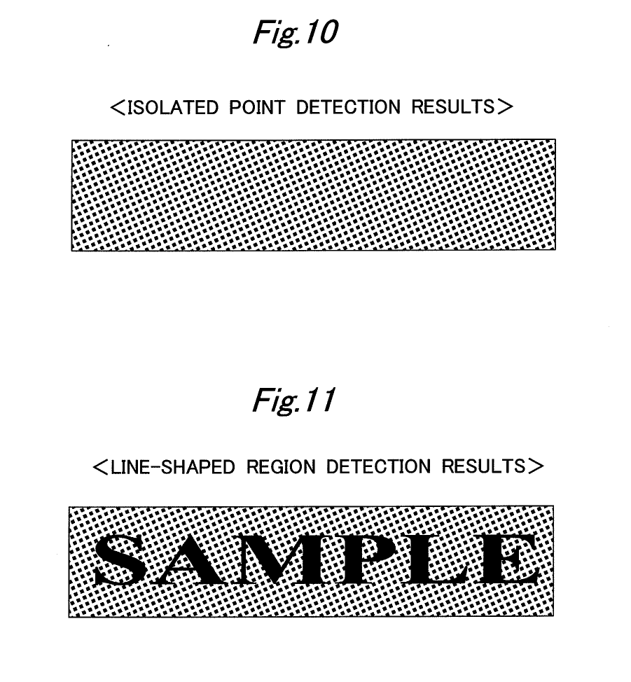

FIGS. 6 to 9 each are a diagram showing an example of a scanned image (a part). FIG. 6 is a diagram showing a scanned image which is a color image (note, however, that in the drawing the scanned image is shown in grayscale). FIG. 6 shows a state in which the red characters “SAMPLE” are depicted with cyan halftone-dot regions being a background. FIGS. 7 to 9 are diagrams respectively showing three primary color planes (an R-plane, a G-plane, and a B-plane) of the scanned image. FIG. 7 is a diagram showing an R-plane, FIG. 8 is a diagram showing a G-plane, and FIG. 9 is a diagram showing a B-plane. FIG. 10 is a diagram showing the processing results of an isolated point detection process in step S11, and FIG. 11 is a diagram showing the processing results of a line-shaped region extraction process in step S12. Note that here a situation is assumed in which the red color of the characters “SAMPLE” is detected slightly deviated from the ideal red color. For example, the red color of the characters “SAMPLE” is a color represented by (R, G, B)=(220, 30, 50).

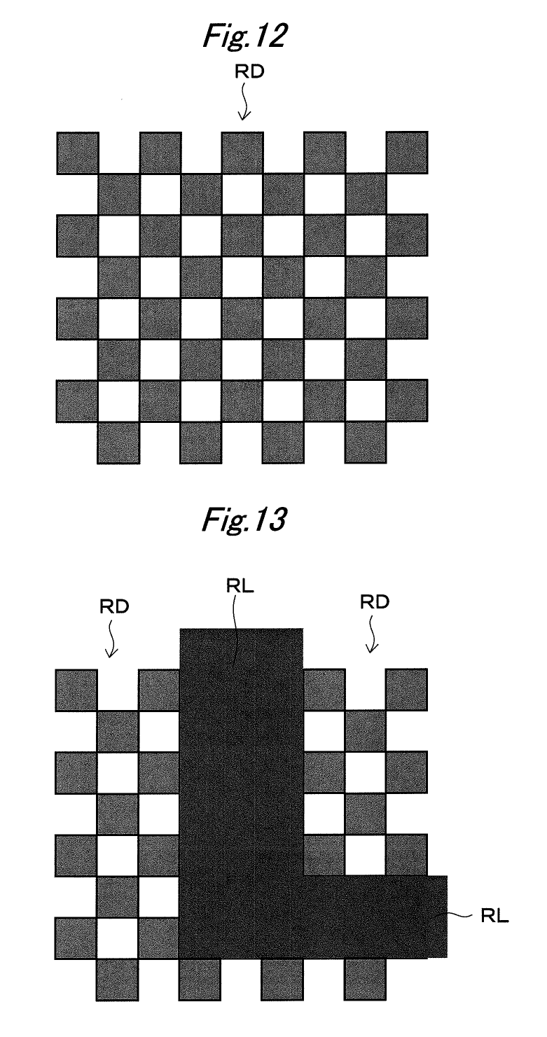

FIG. 12 is an enlarged view showing a halftone-dot region RD in the scanned image, and FIG. 13 is an enlarged view showing portions in the vicinity of a character line region RL in the scanned image. FIG. 12 shows a cyan halftone-dot region RD. In FIG. 13, a red character (here, “L”) is superimposed on a part of the cyan halftone-dot region RD. In these drawings, each halftone dot is shown as a square having a predetermined size (e.g., 3 pixels×3 pixels). Note that for simplicity's sake, figures subsequent to FIG. 12 show halftone dots having a different angle than halftone dots in FIGS. 6 to 11.

First, in step S11 (FIG. 4), the isolated point detecting unit 23 performs an isolated point detection process on an image created based on a scanned image (here, first, the R-plane image (FIG. 7)) and thereby detects isolated points (specifically, black isolated points). A “black isolated point” is an isolated point having a smaller grayscale value than its surrounding pixels. In short, a black isolated point is a black dot isolated from its surrounding.

In the isolated point detection process, the sizes and positions of the isolated points are detected.

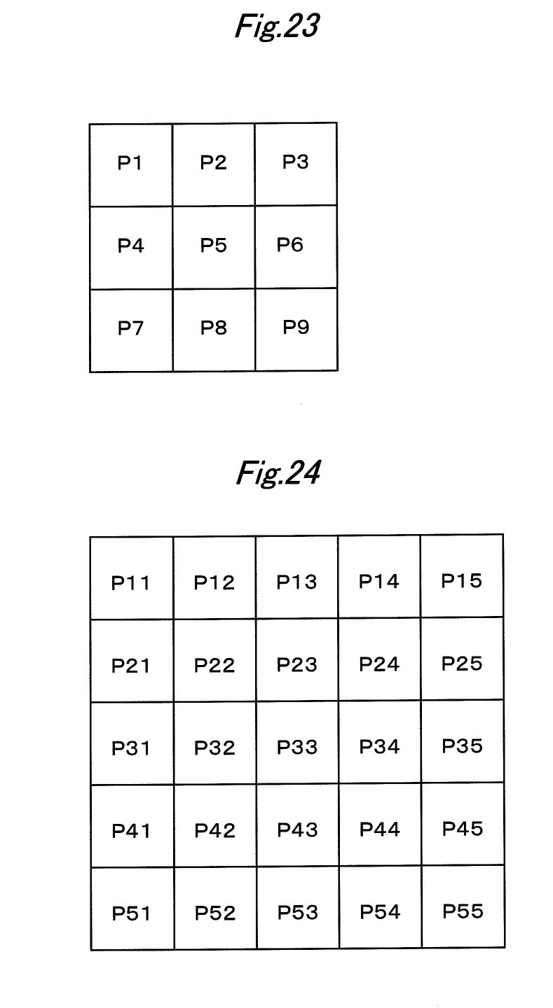

For example, an isolated point (black isolated point) of the isolated point size “1” is detected by a process such as that shown below. Specifically, as shown in FIG. 23, a pixel value V5 of a pixel of interest P5 is compared with a minimum value min (P1 to P3, P4, P6, and P7 to P9) among the pixel values of a plurality of its surrounding pixels P1 to P3, P4, P6, and P7 to P9. Specifically, when a condition is established where the pixel value V5 is smaller than the minimum value min (P1 to P3, P4, P6, and P7 to P9), it is detected that the pixel of interest P5 is a “black isolated point”. In other words, a black isolated point with the position of the pixel of interest P5 being the position of the barycenter is detected. As described above, the size of this black isolated point (isolated point size) is “1 (pixel)”.

Likewise, an isolated point of the isolated point size “3” is detected by a process such as that shown below. Specifically, as shown in FIG. 24, a pixel value V33 of a pixel of interest P33 is compared with the pixel values of a plurality of its surrounding pixels P11 to P15, P21 to P25, P31, P32, P34, P35, P41 to P45, and P51 to P55. For example, when conditions are established where the pixel value V33 is smaller than a minimum value mini of its surrounding pixels (P22 to P24, P32, P34, and P42 to P44) and the minimum value mini is smaller than a minimum value mint of further outer surrounding pixels (P11 to P15, P21, P25, P31, P35, P41, P45, and P51 to P55), it is detected that a pixel group of 3 pixels×3 pixels around the pixel of interest P33 is a “black isolated point”. In other words, a black isolated point with the position of the pixel of interest P33 being the position of the barycenter is detected. As described above, the size of this black isolated point (isolated point size) is “3 (pixels)”. Note that the position of the barycenter of an “isolated point” is also represented as a representative position of the “isolated point”, etc. Note also that in addition to the above-described conditions, when a condition is further established where an average value ave1 of the surrounding pixels (P22 to P24, P32, P34, and P42 to P44) is smaller than an average value ave2 of the further outer surrounding pixels (P11 to P15, P21, P25, P31, P35, P41, P45, and P51 to P55), it may be determined that the above-described pixel group of 3 pixels×3 pixels is a “black isolated point”.

In a likewise manner, black isolated points of a plurality of other sizes are detected. In this manner, the position of the barycenter (representative position) of a black isolated point of each size, etc., are detected. Note that when one same pixel of interest EB is detected in an overlapping manner as isolated points of a plurality of sizes, the largest one of the detected isolated point sizes may be determined to be the isolated point size of the pixel of interest EB.

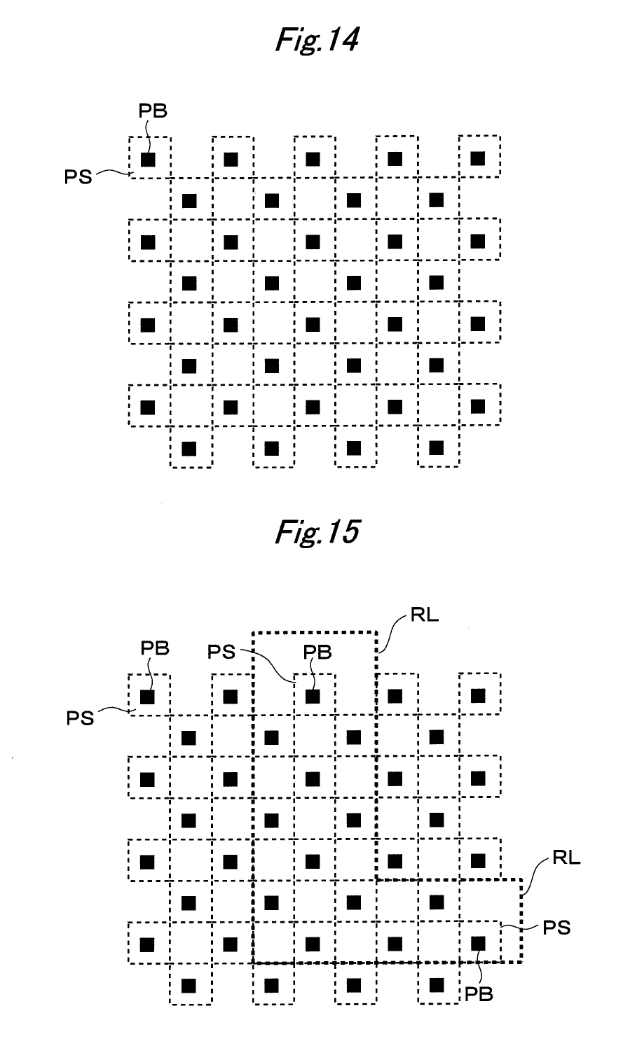

By such a process, for example, as shown in FIGS. 10, 14, and 15, a plurality of isolated points (specifically, black isolated points) are detected. FIG. 14 shows isolated points (black isolated points) PS extracted from the halftone-dot region RD in FIG. 12, and FIG. 15 shows isolated points (black isolated points) PS extracted from the halftone-dot region RD and the character line region RL in FIG. 13. In FIGS. 14 and 15, each isolated point PS of a (3×3) pixel size is shown as a dashed line square and a barycentric pixel PB of each isolated point is shown as a black pixel at its center.

In the above-described manner, a black isolated point detection process based on the R-plane image is performed. Cyan halftone dots are particularly easily detected as black isolated points in the R-plane image (a plane image of red which is a complementary color of cyan).

In a likewise manner, a black isolated point detection process based on the G-plane image is also performed. Note that although the G-plane image in FIG. 8 is shown such that there are no corresponding dots present in halftone-dot regions, when, for example, “cyan” is slightly deviated from the ideal cyan, black isolated points corresponding to halftone dots are also detected in the G-plane image, etc.

Note that in each color component plane, a plurality of dots forming a halftone-dot region of its complementary color are easily detected as isolated points. For example, as described above, in an R-plane, halftone dots of cyan (C) which is a complementary color of red (R) are easily detected as isolated points. Likewise, in a G-plane, halftone dots of magenta (M) which is a complementary color of green (G) are easily detected as isolated points. By using plane images of a plurality of color components, halftone dots of various colors can be favorably detected.

Thereafter, subsequent processes are performed using both of the black isolated points detected based on the R-plane image and the black isolated points detected based on the G-plane image. FIG. 10 shows both of the black isolated points detected based on the R-plane image and the black isolated points detected based on the G-plane image.

Here, as can be seen by referring to FIGS. 6 and 15, etc., isolated points PS are also present inside the character line region (line (including a dot, a straight line, and a curve)-shaped regions forming a character (pixel group)) RL. Hence, as shown in FIG. 15, in particular, isolated points (black isolated points) PS are detected not only in the halftone-dot region but also inside the character line region (an L-shaped region surrounded by a thick dashed line) RL.

If a region where those isolated points PS are present is determined to be a halftone-dot region as it is, then a region including the character line region RL is determined to be a halftone-dot region. Then, as described above, if a smoothing process is performed on such a halftone-dot region, then a smoothing process is also performed on the character line region RL, which may cause a problem of a blurred character edge.

In the embodiment, on the other hand, such a problem is solved by performing processes at and subsequent to the next step S12.

Specifically, first, in step S12, line-shaped regions RE are extracted from a scanned image (here, the min (R, G) image) by the line-shaped region extracting unit 24. More specifically, an edge extraction process is performed on the min (R, G) image, whereby edges of a character, etc., are extracted. Then, closed regions surrounded by the extracted edges are extracted as regions (line-shaped regions) formed of the “lines” of a character, etc. The line-shaped regions RE are extracted as candidate regions for lines forming a character (also referred to as character line candidate regions). Note that the thickness of the line-shaped regions RE is not limited to a one-pixel width and can have various appropriate sizes. The shape of the line-shaped regions RE is, for example, a dot, a straight line, a curve, or the like. A line-shaped region RE here is a region having a smaller grayscale value than the pixels in its outer region (surrounding region) and is a candidate region for a line of a positive-state character (a character with a darker (blacker) color than a background color), and thus is also represented as a “positive type character line candidate region” or a “positive type line-shaped region”.

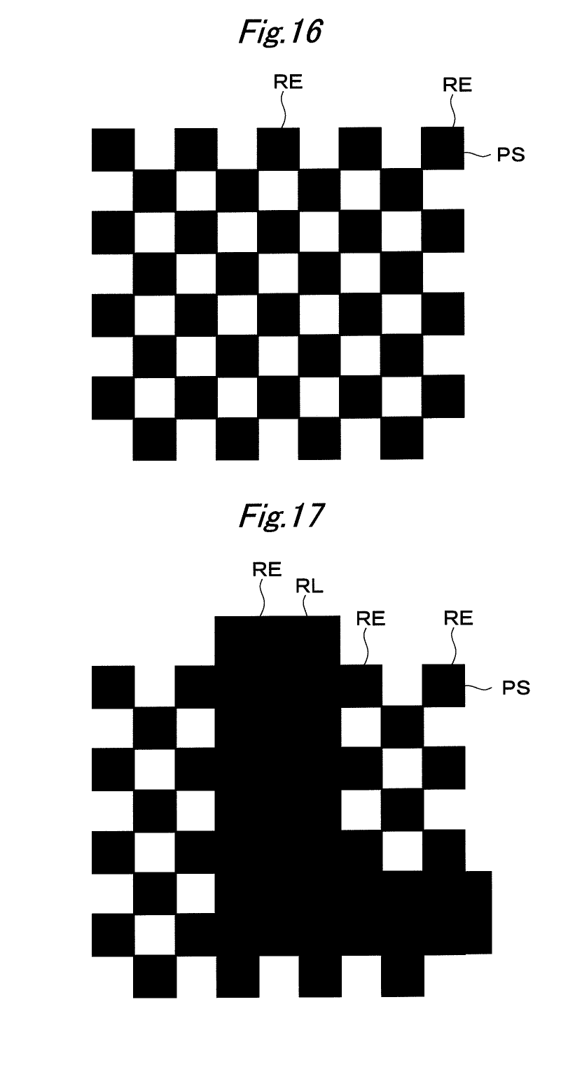

Accordingly, for example, as shown in FIGS. 11, 16, and 17, line-shaped regions (line-shaped regions each including an edge and a region inside the edge) RE are detected. FIG. 16 shows line-shaped regions (positive type line-shaped regions) RE extracted from the halftone-dot region in FIG. 12, and FIG. 17 shows line-shaped regions (positive type line-shaped regions) RE (REp) extracted from the halftone-dot region and the character line region in FIG. 13. In FIGS. 16 and 17, the extracted line-shaped regions are shown in black. Note that a line-shaped region here is a region including a detected edge and a region inside the edge and thus is also referred to as an “edge's inside region” (positive type edge's inside region), etc.

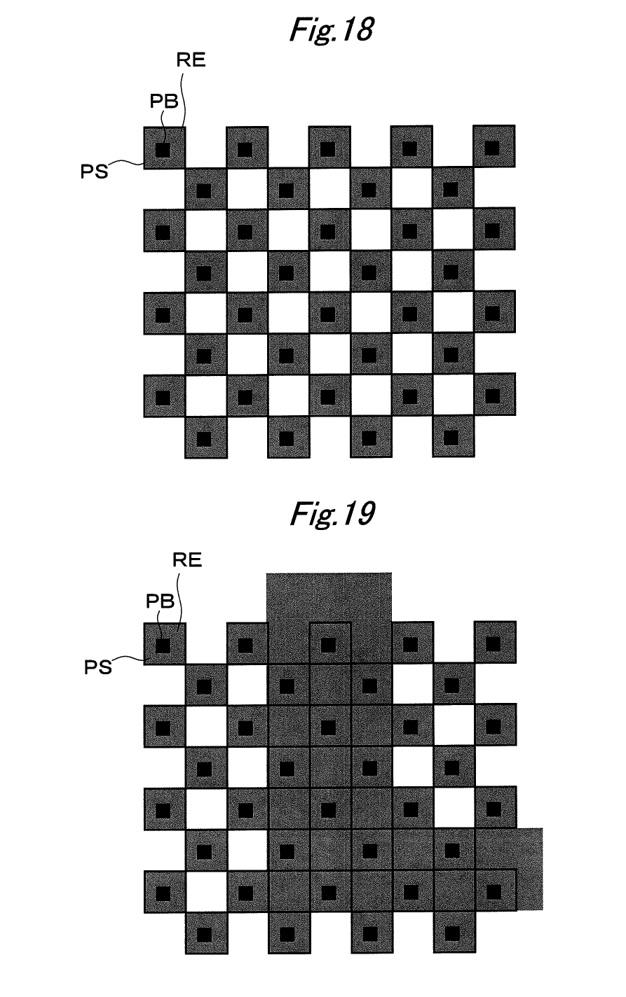

FIG. 18 is a diagram showing the isolated point detection results (FIG. 14) and the line-shaped region extraction results (FIG. 16) in a superimposed manner, and FIG. 19 is a diagram showing the isolated point detection results (FIG. 15) and the line-shaped region extraction results (FIG. 17) in a superimposed manner. Note that, in FIGS. 18 and 19, the isolated point detection results are shown such that the barycentric pixels of the detected isolated points are shown in black, and the line-shaped region extraction results are shown such that the extracted line-shaped regions are shown in light color.

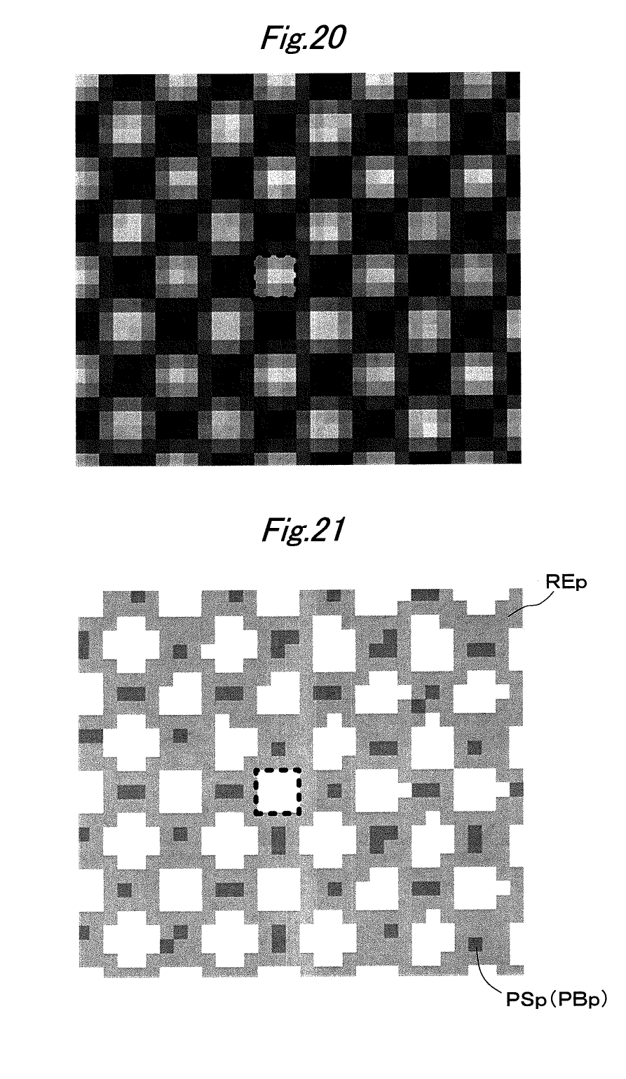

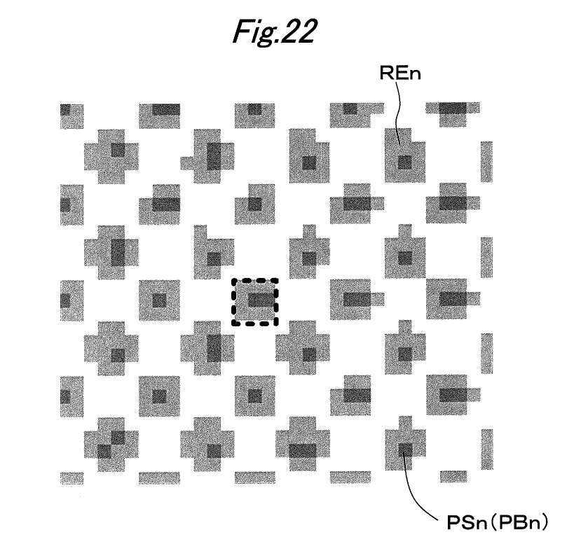

FIGS. 20 to 22 each are a diagram showing an example of the scanned image, etc., in more detail. FIG. 20 is a diagram showing a cyan halftone-dot region in the scanned image. FIG. 21 is a diagram showing the results of detection of black isolated points PSp and the results of extraction of positive type line-shaped regions REp, for the halftone-dot region in FIG. 20. In FIG. 21, a non-white, light colored pixel represents a pixel in a positive type line-shaped region REp, and a dark colored pixel represents a barycentric pixel PBp of a black isolated point PSp. A white pixel represents a pixel that is neither a pixel inside a positive type line-shaped region nor a pixel of a black isolated point. FIG. 22 is a diagram showing the results of detection of white isolated points PSn and the results of extraction of negative type line-shaped regions REn, for the halftone-dot region in FIG. 20. In FIG. 22, a light colored pixel represents a pixel in a negative type line-shaped region REn, and a dark colored pixel represents a barycentric pixel PBn of a white isolated point PSn. A white pixel represents a pixel that is neither a pixel in a negative type line-shaped region nor a pixel of a white isolated point. Note that a “white isolated point” and a “negative type line-shaped region” will be described later.

Here, in the line-shaped region extraction process, an original character line region RL is extracted as a line-shaped region RE and the above-described isolated points PS are also extracted as line-shaped regions RE. For example, in FIG. 17 a character line region RL for the character “L” is extracted as a line-shaped region RE, and isolated points PS around the character “L” are also extracted as line-shaped regions RE. In addition, each isolated point PS in FIG. 16 is also extracted as a line-shaped region RE. Therefore, it is difficult to accurately extract a character line region by using only the results of the line-shaped region extraction process.

On the other hand, in the embodiment, processes at and subsequent to the next step S13 are further performed.

In step S13, the types of a plurality of isolated points (specifically, black isolated points) detected in step S11 are determined by the isolated point type determining unit 25. Specifically, the isolated point type determining unit 25 determines whether each isolated point is a “true isolated point” or a “pseudo isolated point”.

Here, a “pseudo isolated point” is one of a plurality of isolated points (see FIG. 10, etc.) detected from the inside the character line region by the isolated point detection process in step S11 and is detected as an isolated point by erroneous detection despite the fact that it is not an isolated point in the original meaning. Here, such an isolated point is also referred to as a “pseudo isolated point” in order to show that the isolated point is not an original isolated point. On the other hand, an original isolated point is also referred to as a “true isolated point”. Accordingly, two types of isolated points are distinguished from each other.

The isolated point type determining unit 25 determines a pixel that is present in a line-shaped region RE and that is also a representative pixel (barycentric pixel) PB of an isolated point PS, to be a pixel of interest EB, and determines discontinuity of the line-shaped region RE around the pixel of interest EB. In other words, the isolated point type determining unit 25 determines discontinuity of each line-shaped region for each isolated point. An isolated point that is an isolated point PS associated with a pixel of interest EB and that is determined to have discontinuity regarding a line-shaped region RE is determined to be a “true isolated point”. On the other hand, an isolated point that is an isolated point PS associated with a pixel of interest EB and that is determined to have no discontinuity regarding a line-shaped region RE is determined to be a “pseudo isolated point”.

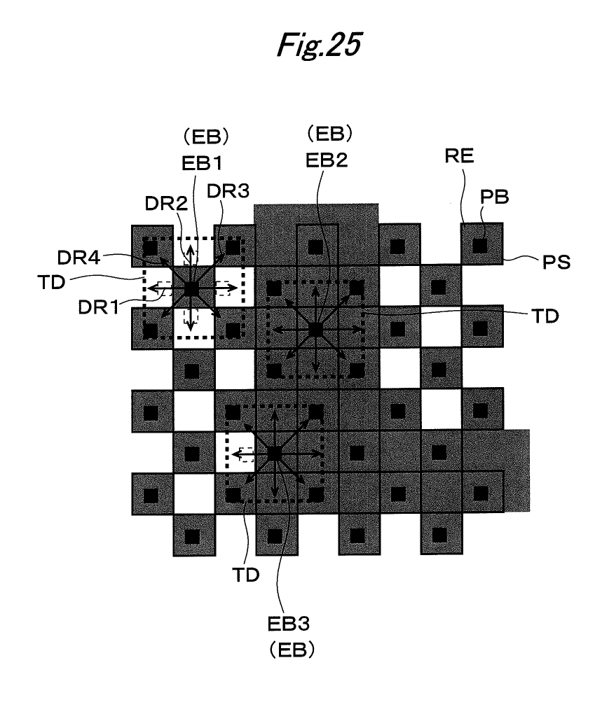

Specifically, as shown in FIG. 5, first, in step S41, a pixel of interest EB is selected. In step S41, a pixel that is present in a line-shaped region and that is a representative pixel (barycentric pixel) of an isolated point is determined to be a pixel of interest EB. For example, a pixel EB1, etc., such as those shown in FIG. 25 are determined to be pixels of interest EB.

Then, in step S42, the size of a detection target region is determined based on the isolated point size of the isolated point PS associated with the pixel of interest EB. For example, the range of a predetermined number of pixels with the pixel of interest EB being at the center (e.g., an isolated point size N of the pixel of interest EB) is determined to be a detection target region TD (see FIG. 25).

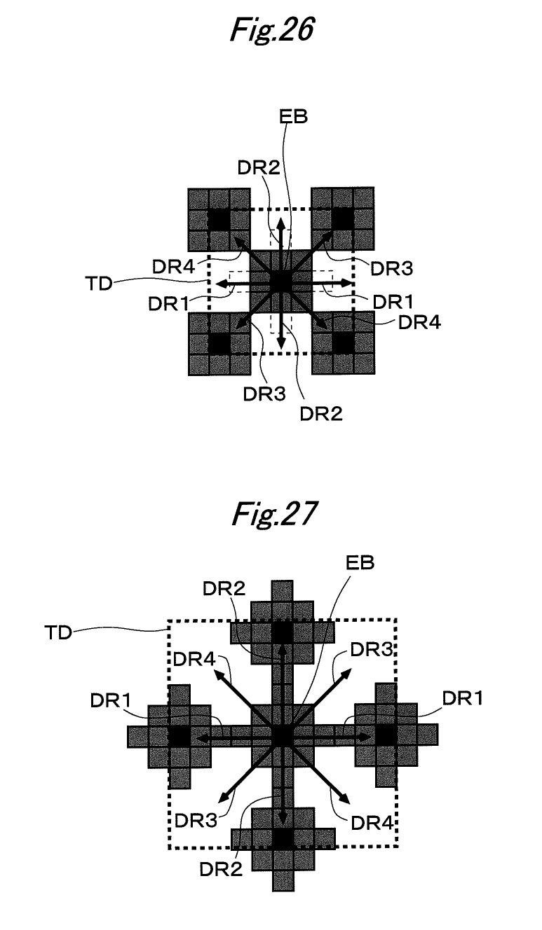

Then, in step S43, the isolated point type determining unit 25 determines discontinuity of the line-shaped region around the pixel of interest EB, in four directions DR1 to DR4 (see FIGS. 25 and 26).

The isolated point type determining unit 25 first determines whether discontinuity of the line-shaped region RE is detected on both sides of the pixel of interest EB in the first direction DR1 (e.g., a direction having an inclination of 0 degrees with respect to an X-axis). The discontinuity detection is performed on the detection target region TD determined in step S42.

Specifically, when the pixel of interest EB is an isolated point of the isolated point size “3” (N=3), a determination as to whether discontinuity of a line-shaped region is detected on “both sides” of the pixel of interest EB in the first direction DR1 is made as follows. More specifically, it is determined whether to satisfy conditions where, in the direction DR1 (X direction), there is a pixel not in a line-shaped region RE within the range of from the pixel of interest EB to the third pixel on the left side (−X side) from the pixel of interest EB (the range including pixels at both ends) and there is a pixel not in a line-shaped region RE within the range of from the pixel of interest EB to the third pixel on the right side (+X side) from the pixel of interest EB (the range including pixels at both ends). In short, it is determined whether there are pixels in “non-line-shaped regions” in both directions, the left and right directions, starting from the pixel of interest EB. When the conditions are satisfied, it is determined that discontinuity of the line-shaped region RE is detected on “both sides” of the pixel of interest EB in the first direction DR1. On the other hand, when the conditions are not satisfied, it is not determined that discontinuity of the line-shaped region RE is detected on “both sides” of the pixel of interest EB in the first direction DR1.

For example, for the pixel of interest EB1 in FIG. 25, in the first direction DR1 (see also FIG. 26), there are pixels not in line-shaped regions RE (outside pixels (white pixels in the drawings)) in the position of the second pixel on the right side from the pixel of interest EB1 and in the position of the second pixel on the left side from the pixel of interest EB1. Therefore, it is determined that discontinuity of a line-shaped region RE is detected on “both sides” of the pixel of interest EB1 in the first direction DR1.

On the other hand, for a pixel of interest EB2 in FIG. 25, in both of the first direction DR1 and the second direction DR2, there are no pixels not in line-shaped regions RE in a detection target region TD (pixels are all present in line-shaped regions RE) and thus it is not determined that discontinuity of a line-shaped region RE is detected. For a pixel of interest EB3 in FIG. 25, in the first direction DR1, there is a pixel not in a line-shaped region RE (a white region surrounded by a thin dashed line in FIG. 25) on the left side of the pixel of interest EB3 in a detection target region TD, but there is no pixel not in a line-shaped region RE on the right side of the pixel of interest EB3 in the detection target region TD. In other words, there is no discontinuity of a line-shaped region RE on the right side of the pixel of interest EB3. Therefore, it is not determined that discontinuity of the line-shaped region RE is detected on “both sides” of the pixel of interest EB3 in the first direction DR1.

For a pixel of interest EB associated with an isolated point of a size other than the isolated point size “3”, too, likewise, the same determination process as that described above is performed in a specific range (the range of a predetermined number of pixels) TD around the pixel of interest EB (specifically, in a detection target region TD according to the isolated point size).

Then, the isolated point type determining unit 25 next determines in a likewise manner whether discontinuity of the line-shaped region RE is detected on both sides of the pixel of interest EB in the second direction DR2 perpendicular to the first direction DR1 (e.g., a direction having an inclination of 90 degrees with respect to the X-axis (i.e., a Y direction)). For example, when, in the second direction DR2 (Y direction), there is a pixel not in a line-shaped region RE within the range of from the pixel of interest EB to an Nth pixel on the lower side (−Y side) from the pixel of interest EB and there is a pixel not in a line-shaped region RE within the range of from the pixel of interest EB to an Nth pixel on the upper side (+Y side) from the pixel of interest EB, it is determined that discontinuity of the line-shaped region RE is detected on both sides of the pixel of interest EB in the second direction DR2.

In addition, the isolated point type determining unit 25 next determines in a likewise manner whether discontinuity of the line-shaped region RE is detected on both sides of the pixel of interest EB in the third direction DR3 (e.g., a direction having an inclination of +45 degrees with respect to the X-axis). For example, when, in the third direction DR3, there is a pixel not in a line-shaped region RE within the range of from the pixel of interest EB to an Nth pixel on the lower left side (−X side and −Y side) from the pixel of interest EB and there is a pixel not in a line-shaped region RE within the range of from the pixel of interest EB to an Nth pixel on the upper right side (+X side and +Y side) from the pixel of interest EB, it is determined that discontinuity of the line-shaped region RE is detected on both sides of the pixel of interest EB in the third direction DR3.

Furthermore, the isolated point type determining unit 25 next determines in a likewise manner whether discontinuity of the line-shaped region RE is detected on both sides of the pixel of interest EB in the fourth direction DR4 perpendicular to the third direction DR3 (e.g., a direction having an inclination of 135 degrees (−45 degrees) with respect to the X-axis). For example, when, in the fourth direction DR4, there is a pixel not in a line-shaped region RE within the range of from the pixel of interest EB to an Nth pixel on the upper left side (−X side and +Y side) from the pixel of interest EB and there is a pixel not in a line-shaped region RE within the range of from the pixel of interest EB to an Nth pixel on the lower right side (+X side and −Y side) from the pixel of interest EB, it is determined that discontinuity of the line-shaped region RE is detected on both sides of the pixel of interest EB in the fourth direction DR4.

Then, in step S44, the isolated point type determining unit 25 determines the type of the isolated point associated with the pixel of interest EB, according to whether a predetermined criterion is satisfied. Here, whether discontinuity of the line-shaped region RE is detected on both sides of the pixel of interest EB in a set of two perpendicular directions ((DR1 and DR2) or (DR3 and DR4)) among the four directions is adopted as the predetermined criterion.

Specifically, when the isolated point type determining unit 25 determines that discontinuity of the line-shaped region RE is detected on both sides of the pixel of interest EB in both of the two directions DR1 and DR2 in given two perpendicular directions (DR1 and DR2), the isolated point type determining unit 25 determines that the isolated point associated with the pixel of interest EB is a “true isolated point” (step S45). Likewise, when the isolated point type determining unit 25 determines that discontinuity of the line-shaped region RE is detected on both sides of the pixel of interest EB in both of the two directions DR3 and DR4 in the other two perpendicular directions (DR3 and DR4), too, the isolated point type determining unit 25 determines that the isolated point associated with the pixel of interest EB is a “true isolated point” (step S45). Such determinations are made because when “disconnection” of the line-shaped region RE on both sides of the pixel of interest EB is present in both of the two perpendicular directions in the above-described manner, the pixel of interest EB (specifically, the isolated point associated with the pixel of interest EB) is highly likely to be an “isolated point” (true isolated point) in the original meaning.

On the other hand, isolated points other than “true isolated points” are determined to be “pseudo isolated points”. Specifically, when it is not determined that discontinuity of the line-shaped region RE is detected on both sides of the pixel of interest EB in at least one of given two perpendicular directions (DR1 and DR2) and it is not determined that discontinuity of the line-shaped region RE is detected on both sides of the pixel of interest EB in at least one of the other two perpendicular directions (DR3 and DR4), the isolated point associated with the pixel of interest EB is determined to be a “pseudo isolated point” (step S46). Such a determination is made because when “disconnection” of the line-shaped region RE on both sides of the pixel of interest EB is not present in at least one of two perpendicular directions in the above-described manner, the pixel of interest EB is highly likely not to be an original isolated point.

For example, for the pixel of interest EB1 in FIG. 25, discontinuity of a line-shaped region RE is detected on “both sides” of the pixel of interest EB1 in the first direction DR1. In addition, for the pixel of interest EB1, discontinuity of the line-shaped region RE is detected on “both sides” of the pixel of interest EB1 in the second direction DR2, too. In other words, for the pixel of interest EB1, “discontinuity of the line-shaped region” is detected on both sides of the pixel of interest EB1 in both of the first direction DR1 and the second direction DR2. Therefore, an isolated point associated with the pixel of interest EB1 is determined to be a “true isolated point”.

On the other hand, for the pixel of interest EB2 in FIG. 25, in both of the first direction DR1 and the second direction DR2, there are no pixels not in line-shaped regions RE in a detection target region TD and thus discontinuity of a line-shaped region RE is not detected. Likewise, in both of the third direction DR3 and the fourth direction DR4, too, there are no pixels not in line-shaped regions RE in the detection target region TD and thus discontinuity of the line-shaped region RE is not detected. Therefore, an isolated point associated with the pixel of interest EB2 is determined to be a “pseudo isolated point”.

For the pixel of interest EB3 in FIG. 25, there is no discontinuity of a line-shaped region RE on the right side of the pixel of interest EB3 and thus it is not determined that discontinuity of the line-shaped region RE is detected on “both sides” of the pixel of interest EB3 in the first direction DR1. Note that in the second direction, too, it is not determined that discontinuity of the line-shaped region RE is detected on “both sides” of the pixel of interest EB3. Furthermore, in both of the third direction DR3 and the fourth direction DR4, too, there are no pixels not in line-shaped regions RE in a detection target region TD and thus discontinuity of the line-shaped region RE is not detected. Therefore, an isolated point associated with the pixel of interest EB3 is determined to be a “pseudo isolated point” (pseudo black isolated point).

Here, in FIG. 25, etc., the case in which the halftone-dot angle is 45 degrees is mainly assumed. In this case, it is particularly useful to determine, as described above, when discontinuity of a line-shaped region RE is detected on both sides of a pixel of interest EB in both of the two directions DR1 and DR2 perpendicular to each other, an isolated point (black isolated point) associated with the pixel of interest EB to be a “true isolated point” (true black isolated point) (step S45).

Note, however, that there is also a case in which the halftone-dot angle is 0 degrees. In that case, it is particularly useful to determine, when discontinuity of a line-shaped region RE is detected on both sides of a pixel of interest EB in both of the two directions DR3 and DR4 perpendicular to each other, an isolated point associated with the pixel of interest EB to be a “true isolated point” (step S45). In this case, as shown in FIG. 27, since discontinuity of a line-shaped region RE for a halftone dot is easily detected in the directions DR3 and DR4, a true isolated point for such a halftone dot is easily and accurately detected.

Therefore, to more appropriately handle halftone dots with various angles, it is preferable to perform, as described above, an isolated point type determination operation using discontinuity not only for the directions DR1 and DR2 but also for the directions DR3 and DR4.

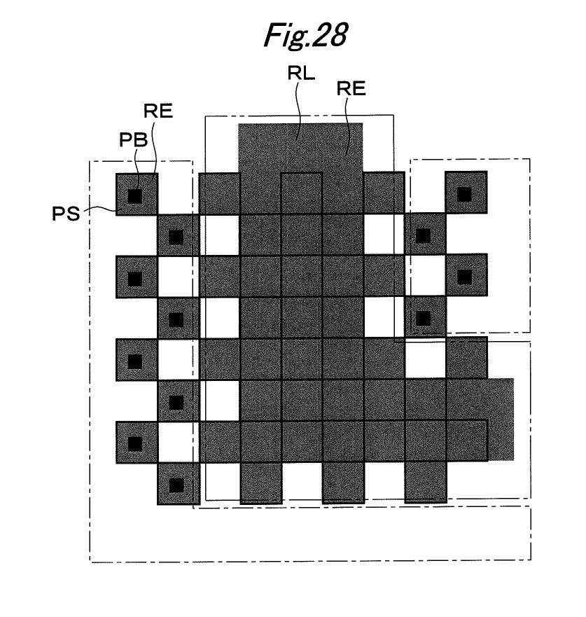

In the next step S47, a process of removing pseudo isolated points (pseudo black isolated points) from a plurality of isolated points (black isolated points) detected in step S11 (FIG. 4), based on the isolated point type determination results obtained in steps S44 to S46 is performed (see FIG. 28).

Then, in step S48, it is determined whether the processes in steps S41 to S46 have been done for all of the isolated points (black isolated points) in the line-shaped regions RE. If there is a remaining undone pixel, then processing returns to step S41. On the other hand, if it is determined that the processes in steps S41 to S46 have been done for all of the isolated points in the line-shaped regions RE, then the process in step S13 is completed. In this manner, the processes in steps S41 to S46 are performed for all of the isolated points (black isolated points) in the line-shaped regions RE.

By the processes such as those described above (steps S41 to S48), all of the pseudo isolated points (pseudo black isolated points) are removed from the isolated point detection results obtained in step S11.

As a result, ideally, of a plurality of isolated points detected in step S11 (see FIG. 10), all of the pseudo isolated points present in the character line regions RL for the characters “SAMPLE” are removed. FIG. 28 is a diagram showing isolated points (true isolated points), etc., after the removal of pseudo isolated points. For example, as can be seen by comparing FIGS. 28 and 19, in FIG. 28, pseudo isolated points are removed from a plurality of isolated points in FIG. 19. Specifically, isolated points (pseudo black isolated points) are removed from a substantially L-shaped line-shaped region RE in the center of the drawing (a region including a character line region RL).

In the next step S14, a halftone-dot region determination process based on the isolated point type determination results is performed. Specifically, the halftone-dot region determining unit 27 determines a region in which pseudo isolated points (pseudo black isolated points) are removed from a plurality of isolated points (black isolated points) (in other words, a region not including pseudo black isolated points but including true black isolated points among a plurality of black isolated points), to be a halftone-dot region. More specifically, the halftone-dot region determining unit 27 performs a process of extending each isolated point (black isolated point) to its adjacent isolated point and thereby creates a continuous region including the isolated points (black isolated points), and determines the continuous region to be a halftone-dot region. For example, in FIG. 28, a region surrounded by a dash-dotted line is determined to be a halftone-dot region.

In step S15, a line-shaped region determination process is performed. Specifically, the character line region determining unit 26 determines a line-shaped region RE (positive type line-shaped region REp) from which true isolated points (true black isolated points) are removed, to be a character line region. More specifically, the character line region determining unit 26 modifies a line-shaped region by excluding a region obtained by extending each true isolated point (true black isolated point) according to its isolated point size, from a line-shaped region RE extracted in step S12. Then, the line-shaped region after the exclusion (after the modification) is determined to be a character line region. For example, in FIG. 28, an L-shaped region surrounded by a dash-double-dotted line is determined to be a character line region.

In steps S21 to S25 (FIG. 4), too, the same operations as those in steps S11 to S15 are performed. Note, however, that the operations are different in that, for example, the positive and negative are reversed, a “white isolated point” is adopted instead of a “black isolated point”, and a “negative type line-shaped region” is adopted instead of a “positive type line-shaped region”.

Specifically, first, in step S21, the isolated point detecting unit 23 performs an isolated point detection process on images (the R-plane image, etc.) created based on the scanned image and thereby detects isolated points (specifically, white isolated points). A “white isolated point” is an isolated point having a larger grayscale value than its surrounding pixels. In short, a “white isolated point” is a white dot isolated from its surrounding.

Note that detection of a white isolated point differs from detection of a black isolated point in that, for example, the large and small of their grayscale values are reversed. For example, a white isolated point of the isolated point size “1” is detected by a process such as that shown below. Specifically, when a condition is established where the pixel value V5 of a pixel of interest P5 (see FIG. 23) is larger than the maximum value max of its surrounding pixels (P1 to P3, P4, P6, and P7 to P9), it is detected that the pixel of interest P5 is a “white isolated point”. In other words, a white isolated point with the position of the pixel of interest P5 being the position of the barycenter is detected. Likewise, the operation of detecting white isolated points of other sizes is also performed such that the large and small of their grayscale values, etc., are reversed from those for the operation of detecting black isolated points.

Then, in step S22, line-shaped regions RE are extracted from a scanned image (here, the max (R, G, B) image) by the line-shaped region extracting unit 24. Specifically, an edge extraction process is performed on the max (R, G, B) image, whereby edges of a character, etc., are extracted. Then, closed regions surrounded by the extracted edges are extracted as line-shaped regions (character line candidate regions). Note that a line-shaped region RE is a region having a larger grayscale value than the pixels in its outer region (surrounding region) and is a candidate region for a line of a negative-state character (a character with a lighter (whiter) color than a background color), and thus is also represented as a “negative type character line candidate region” or a “negative type line-shaped region”.

As a result, for example, as shown in FIG. 22, white isolated points PS (PSn) for the halftone-dot region in FIG. 20 are detected by the process in step S21 and negative type line-shaped regions RE (REn) for the halftone-dot region in FIG. 20 are detected by the process in step S22. Note that in FIG. 22, for the sake of expediency of depiction, light and dark are shown reversed again and a relatively white portion in a grayscale image is shown to be relatively black. Hence, a barycentric pixel PB (PBn) of a white isolated point PS (PSn) is shown in dark color, and a negative type line-shaped region RE (REn) which is originally white or light colored is shown in darker color than the white color of its outer region (non-negative type line-shaped region) (note, however, that the negative type line-shaped region RE (REn) is shown in a lighter color than that of the barycentric pixel PBn of the white isolated point PSn).

Then, in step S23, the types of a plurality of isolated points (specifically, white isolated points) detected in step S21 are determined by the isolated point type determining unit 25. The process in this step S23 is the same as that in step S13.

Accordingly, it is determined whether each white isolated point is a “true white isolated point” or a “pseudo white isolated point”, and a process of removing pseudo isolated points (pseudo white isolated points) from a plurality of isolated points (white isolated points) detected in step S21 is performed.

In the next step S24, a halftone-dot region determination process based on the isolated point type determination results is performed. Specifically, the halftone-dot region determining unit 27 determines a region in which pseudo white isolated points are removed from a plurality of white isolated points (in other words, a region not including pseudo white isolated points but including true white isolated points among a plurality of white isolated points), to be a halftone-dot region. More specifically, the halftone-dot region determining unit 27 performs a process of extending each white isolated point to its adjacent white isolated point and thereby creates a continuous region including true white isolated points, and determines the continuous region to be a halftone-dot region.

Furthermore, in step S25, a line-shaped region determination process is performed. Specifically, the character line region determining unit 26 determines a negative type line-shaped region REn from which true white isolated points are removed, to be a character line region. More specifically, the character line region determining unit 26 modifies a negative type line-shaped region by excluding a region obtained by extending each true white isolated point according to its isolated point size, from a negative type line-shaped region REn extracted in step S22. Then, the negative type line-shaped region after the exclusion (after the modification) is determined to be a character line region.

Thereafter, in step S31, the results of determinations in steps S14 and S24 are integrated. Specifically, two regions, a halftone-dot region determined in step S14 by a combination of black isolated points PSp and positive type line-shaped regions REp and a halftone-dot region determined in step S24 by a combination of white isolated points PSn and negative type line-shaped regions REn, (in other words, the OR region of the two regions (union region)) are finally determined to be a “halftone-dot region”.

In addition, in step S32, the results of determinations in steps S15 and S25 are integrated. Specifically, two regions, a character line region determined in step S15 by a combination of black isolated points PSp and positive type line-shaped regions REp and a character line region determined in step S25 by a combination of white isolated points PSn and negative type line-shaped regions REn, (in other words, the OR region of the two regions (union region)) are finally determined to be a “character line region”.

According to the processes such as those described above, in steps S13 and S23, pseudo isolated points are appropriately removed from line-shaped regions RE which are character line candidate regions. For example, as shown in FIG. 28, pseudo isolated points can be removed from the L-shaped “character line region”. Then, in steps S14 and S24, a region from which pseudo isolated points are removed and which includes only true isolated points is appropriately determined to be a halftone-dot region. Hence, halftone-dot regions can be more appropriately extracted from an image containing both characters and halftone dots.

Therefore, when a smoothing process is performed on halftone-dot regions, the smoothing process is not performed on a character line region RL. Accordingly, the problem of a blurred character edge is avoided.

In steps S15 and S25, of true isolated points and pseudo isolated points, only the true isolated points are appropriately removed from line-shaped regions RE which are character line candidate regions. For example, as shown in FIG. 28, a region from which true isolated points present outside the L-shaped “character line region” are removed is appropriately determined to be a character line region. Hence, a character line region can be more appropriately extracted from an image containing both characters and halftone dots.

<3. Variants, Etc.>

Although the embodiment of the present invention is described above, the present invention is not limited to the content described above.

For example, although in the above-described embodiment, in step S42 (FIG. 5), a detection target region TD is determined to be a region having, on each side from a pixel of interest EB, a size in the range of the number of pixels which is the same as an isolated point size N, the present invention is not limited thereto. Specifically, a detection target region TD may be determined to be a region having a size in the range of the number of pixels (N+α) on each side from a pixel of interest EB. The value α is, for example, one pixel to several pixels. Alternatively, the value α may be a negative value (e.g., −one pixel to−several pixels).

Although in the above-described embodiment the case is exemplified in which discontinuity of a line-shaped region in two sets of two perpendicular directions (DR1 and DR2) and (DR3 and DR4) is determined, the present invention is not limited thereto, and discontinuity of a line-shaped region in other perpendicular directions (DR5 and DR6) may be determined. For example, a direction having an inclination angle of 30 degrees with respect to the X-axis and a direction having an inclination angle of 120 degrees (−60 degrees) with respect to the X-axis may be adopted as DR5 and DR6, respectively.

When a halftone-dot direction is known in advance, it is preferable to determine discontinuity of a line-shaped region in two perpendicular directions which are rotated by 45 degrees from the halftone-dot direction. For example, when it is known that the halftone-dot angle is 45 degrees, it is preferable to determine whether discontinuity of a line-shaped region is detected on both sides of a pixel of interest EB in two directions, a direction DR2 having an inclination angle of 90 degrees with respect to the X-axis and a direction DR1 having an inclination angle of 0 degrees with respect to the X-axis. Note that a halftone-dot direction may be detected by performing, for example, a process using a plurality of filters (linear direction detection filters) for pixel array detection for different specific directions (e.g., 0 degrees, 45 degrees, 90 degrees, and 135 degrees), on an image resulting from isolated point detection results (see FIG. 10) obtained in step S11, etc. For each direction detection filter, for example, an image processing filter of a predetermined size may be used in which “1” pixels are arranged only in positions in a corresponding detection direction (e.g., 45 degrees) from the center and “0” pixels are arranged in other positions. Then, a specific direction for a direction detection filter with which the largest computation result (an average value, etc.) is obtained may be determined to be the halftone-dot direction.

In particular, when a halftone-dot direction is known in advance, discontinuity of a line-shaped region only in two directions which are rotated by 45 degrees from the halftone-dot direction may be determined. For example, when it is known that the halftone-dot angle is 45 degrees, an isolated point type determination operation may be performed by determining only discontinuity of a line-shaped region in the above-described two perpendicular directions (DR1 and DR2). According to this, processing efficiency can be achieved.

Although in the above-described embodiment the case is exemplified in which an isolated point type is determined according to whether discontinuity of a line-shaped region is detected on both sides of a pixel of interest EB in both of two perpendicular directions (e.g., (DR1 and DR2)), the present invention is not limited thereto.

Specifically, an isolated point type may be determined according to whether discontinuity of a line-shaped region is detected on both sides of a pixel of interest EB in at least one of a plurality of directions (e.g., the above-described four directions DR1 to DR4). More specifically, when a condition is satisfied where discontinuity of a line-shaped region is detected on both sides of a pixel of interest EB in at least one of a plurality of different directions (DR1 to DR4, etc.), an isolated point associated with the pixel of interest EB may be determined to be a “true isolated point”. On the other hand, when the condition is not satisfied, the isolated point associated with the pixel of interest EB may be determined to be a “pseudo isolated point”.

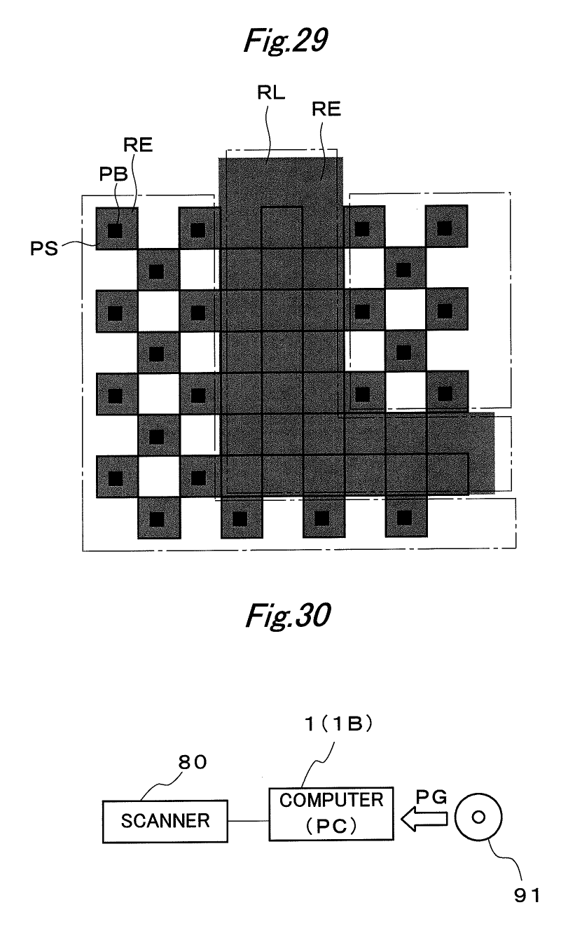

FIG. 29 is a diagram showing a state in which pseudo isolated points thus determined are removed. As shown in FIG. 29, by a determination process, etc., according to such a variant, too, pseudo isolated points in line-shaped regions RE (in particular, a character line region RL) can be favorably removed. Note that comparing with FIG. 28, in FIG. 29, relatively many isolated points remain in halftone-dot regions (regions surrounded by dash-dotted lines) and thus it can be seen that in the variant the condition for determining an isolated point to be a true isolated point is loosened over that in the above-described embodiment.

Although in the above-described embodiment the case of performing two processes, the process in steps S11 to S15 and the process in steps S21 to S25, is exemplified, the present invention is not limited thereto and only one of the two processes may be performed. For example, of the two processes, only the process in steps S11 to S15 may be performed.

Although in the above-described embodiment the case is exemplified in which line-shaped regions are extracted by performing an edge extraction process, etc., on a scanned image in step S12, etc., the present invention is not limited thereto. For example, positive type line-shaped regions may be extracted by performing a low luminance region extraction process, etc., on a scanned image, etc. Likewise, negative type line-shaped regions may be extracted by performing a high luminance region extraction process, etc., on a scanned image, etc. Note that at this time since regions (solid filled regions, etc.) other than character line regions are excluded, it is further preferable to extract the above-described line-shaped regions, with regions having an area of a certain size or more or having a certain thickness or more being excluded.

Although in the above-described embodiment a scanned image created by the image reading unit 2 is exemplified as image data (digital image data), the present invention is not limited thereto. For example, image data may be image data for printing (printing image data) sent from an external device, etc. The printing image data may be generated by a scanning process or may be generated by predetermined application software (a word processor, a graphics processor, etc.).

Although in the above-described embodiment the case in which the MFP 1 functions as an image processing apparatus is exemplified, the present invention is not limited thereto, and a computer (a personal computer, etc.) may function as an image processing apparatus.

FIG. 30 is a schematic diagram showing an image processing apparatus 1 (1B) according to such a variant. The image processing apparatus 1 (1B) is configured by a computer such as a personal computer. To the image processing apparatus 1B, a scanned image created by a scanner apparatus 80 is inputted.

The image processing apparatus (computer) 1B performs image processing such as that described above, on the scanned image. Specifically, the image processing apparatus (computer) 1B reads, from various types of non-transitory (or portable) computer-readable recording media 91 (e.g., a flexible disk, a CD-ROM, a DVD-ROM, etc.) having recorded therein a predetermined program PG, the program PG and executes the program PG using its CPU, etc., and thereby implements the same functions as those of the above-described controller 9. Accordingly, the image processing apparatus (computer) 1B can perform the same image processing, etc., as those in the above-described embodiment. Note that the program PG may be supplied through a recording medium or may be supplied, for example, by being downloaded over the Internet.

While the invention has been shown and described in detail, the foregoing description is in all aspects illustrative and not restrictive. It is therefore understood that numerous modifications and variations can be devised without departing from the scope of the invention.

What is claimed is:

1. An image processing apparatus comprising:
an isolated point detecting unit that detects isolated points in image data;
a line-shaped region extracting unit that extracts line-shaped regions in the image data, as character line candidate regions;
an isolated point type determining unit that determines a representative pixel of each isolated point in each line-shaped region to be a pixel of interest, determines discontinuity of each line-shaped region around the pixel of interest for each isolated point, determines an isolated point determined to have discontinuity to be a true isolated point, and determines an isolated point determined to have no discontinuity to be a pseudo isolated point; and
a halftone-dot region determining unit that determines a halftone-dot region, based on isolated point type determination results for the respective isolated points detected by the isolated point detecting unit.

2. The image processing apparatus according to claim 1, wherein
when, in a specific range around the pixel of interest, discontinuity of a line-shaped region is detected on both sides of the pixel of interest in a first direction and discontinuity of the line-shaped region is detected on both sides of the pixel of interest in a second direction perpendicular to the first direction, the isolated point type determining unit determines an isolated point associated with the pixel of interest to be a true isolated point.

3. The image processing apparatus according to claim 2, wherein
when, in the specific range around the pixel of interest, discontinuity of the line-shaped region is detected on both sides of the pixel of interest in a third direction and discontinuity of the line-shaped region is detected on both sides of the pixel of interest in a fourth direction perpendicular to the third direction, the isolated point type determining unit determines an isolated point associated with the pixel of interest to be a true isolated point, the third direction being different from the first direction and the second direction.

4. The image processing apparatus according to claim 1, wherein
the isolated point type determining unit determines an isolated point associated with the pixel of interest to be a true isolated point on condition that, in a specific range around the pixel of interest, discontinuity of a line-shaped region is detected on both sides of the pixel of interest in at least one of a plurality of different directions.

5. The image processing apparatus according to claim 1, wherein
the halftone-dot region determining unit determines a region to be a halftone-dot region, the region not including a pseudo isolated point but including a true isolated point among the isolated points detected by the isolated point detecting unit.

6. The image processing apparatus according to claim 1, wherein
the isolated point detecting unit detects, based on the image data, an isolated point having a smaller grayscale value than surrounding pixels thereof, as a black isolated point,
the line-shaped region extracting unit detects, based on the image data, a line-shaped region having a smaller grayscale value than surrounding pixels thereof, as a positive type line-shaped region, and
the isolated point type determining unit determines a representative pixel of each black isolated point in each positive type line-shaped region to be a pixel of interest, determines discontinuity of the positive type line-shaped region around the pixel of interest for each black isolated point, determines a black isolated point determined to have discontinuity to be a true isolated point, and determines a black isolated point determined to have no discontinuity to be a pseudo isolated point.

7. The image processing apparatus according to claim 1, wherein
the isolated point detecting unit detects, based on the image data, an isolated point having a larger grayscale value than surrounding pixels thereof, as a white isolated point,
the line-shaped region extracting unit detects, based on the image data, a line-shaped region having a larger grayscale value than surrounding pixels thereof, as a negative type line-shaped region, and
the isolated point type determining unit determines a representative pixel of each white isolated point in each negative type line-shaped region to be a pixel of interest, determines discontinuity of the negative type line-shaped region around the pixel of interest for each white isolated point, determines a white isolated point determined to have discontinuity to be a true isolated point, and determines a white isolated point determined to have no discontinuity to be a pseudo isolated point.

8. The image processing apparatus according to claim 1, wherein
the isolated point detecting unit:
detects, based on the image data, an isolated point having a smaller grayscale value than surrounding pixels thereof, as a black isolated point; and
detects, based on the image data, an isolated point having a larger grayscale value than surrounding pixels thereof, as a white isolated point,
the line-shaped region extracting unit:
detects, based on the image data, a line-shaped region having a smaller grayscale value than surrounding pixels thereof, as a positive type line-shaped region; and
detects, based on the image data, a line-shaped region having a larger grayscale value than surrounding pixels thereof, as a negative type line-shaped region,
the isolated point type determining unit:
determines a representative pixel of each black isolated point in each positive type line-shaped region to be a pixel of interest, determines discontinuity of the positive type line-shaped region around the pixel of interest for each black isolated point, determines a black isolated point determined to have discontinuity to be a true black isolated point, and determines a black isolated point determined to have no discontinuity to be a pseudo black isolated point; and
determines a representative pixel of each white isolated point in each negative type line-shaped region to be a pixel of interest, determines discontinuity of the negative type line-shaped region around the pixel of interest for each white isolated point, determines a white isolated point determined to have discontinuity to be a true white isolated point, and determines a white isolated point determined to have no discontinuity to be a pseudo white isolated point, and
the halftone-dot region determining unit determines an OR region of a first region and a second region to be a halftone-dot region, the first region not including the pseudo black isolated point but including the true black isolated point among black isolated points detected by the isolated point detecting unit, and the second region not including the pseudo white isolated point but including the true white isolated point among the white isolated points detected by the isolated point detecting unit.

9. A non-transitory computer-readable recording medium having recorded therein a program for causing a computer to perform the steps of:
(a) detecting isolated points in image data;
(b) extracting line-shaped regions in the image data, as character line candidate regions;
(c) determining a representative pixel of each isolated point in each line-shaped region to be a pixel of interest, determining discontinuity of each line-shaped region around the pixel of interest for each isolated point, determining an isolated point determined to have discontinuity to be a true isolated point, and determining an isolated point determined to have no discontinuity to be a pseudo isolated point; and
(d) determining a halftone-dot region, based on isolated point type determination results obtained in the step (c) for the respective isolated points detected in the step (a).
